(19) United States
(12) Patent Application Publication
(10) Pub. No.: US 2012/0267464 A1
(43) Pub. Date: Oct. 25, 2012

(54) SHREDDER WITH ADJUSTABLE PAPER FEEDING OPENING

(75) Inventor: Jia-Wang JIANG, NingBo City (CN)

(73) Assignee: Michilin Prosperity Co., Ltd., SanChung City (TW)

(21) Appl. No.: 13/092,415

(22) Filed: Apr. 22, 2011

(51) Int. Cl. B02C 18/16; B02C 23/02

(52) U.S. Cl. 241/222

(57) ABSTRACT

A shredder with adjustable paper feeding opening includes a top cover and a shredder body. The top cover has a paper inlet, beneath one side of which is a rotatable adjusting bar. The adjusting bar is parallel to the paper inlet. A paper feeding opening is formed between the adjusting bar and the other side of the paper inlet. The adjusting bar is controlled by an adjusting device. The width of the paper inlet is changed by controlling the adjusting bar. This solves the problems of difficulty in backing paper and too many/few pieces of paper entering at one time.

### BACKGROUND OF THE INVENTION

1. Field of Invention

The invention relates to a shredder and, in particular, to a shredder with adjustable paper feeding opening.

2. Related Art

With the coming of knowledge economy era, more information has values and impacts. Therefore, a lot of such information needs to be encrypted. To reduce the risk of releasing secret information printed on paper, companies make use of various kinds of shredders to destroy such information.

Existing shredders generally consist of a top cover and a shredder body. The top cover has a paper inlet. The shredder body contains blades. Sheets of paper enter the shredder body via the paper inlet. The paper is then cut into pieces by the blades, The width of the paper inlet of such shredders is fixed. If the width is too small, then there might be problems in backing paper. If the width is too big, then the shredder may be damaged when processing too many sheets. Therefore, the shredders need to be improved.

### SUMMARY OF THE INVENTION

In view of the foregoing, the invention provides a shredder with adjustable paper feeding opening. The disclosed shredder includes a top cover and a shredder body, The top cover has a paper inlet. A rotatable adjusting bar is provided under on side of the paper inlet. The adjusting bar is parallel to the paper inlet. A paper feeding opening forms between the adjusting bar and the other side of the paper inlet. The adjusting bar is controlled by an adjusting device.

The adjusting device according to a first embodiment of the invention includes a knob on the top cover, a worm connected with the knob, and a worm gear connected with the worm. The worm wheel is connected and fixed to one end of the adjusting bar.

The adjusting device according to a second embodiment of the invention includes a handle on the top cover and two fixing bases supporting the adjusting bar. One end of the adjusting bar goes through the corresponding fixing base to connect to the handle.

The fixing bases have fixing holes, around which are concave parts for the adjusting bar to rotate.

By rotating the adjusting bar, one can effectively control the width of the paper inlet. The invention thus overcomes the difficulty in backing paper or the problems due to too many sheets of paper to process at a time. The quality of the product is apparently higher.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view of the appearance of the first embodiment of the invention;

FIG. 2 is a schematic view of the first embodiment with the top cover removed;

FIG. 3 is a schematic view of the A-A cross section in FIG. 1;

FIG. 4 is a schematic view of the appearance of the second embodiment of the invention;

FIG. 5 is a schematic view of the second embodiment with the top cover removed;

FIG. 6 is a schematic view of the B-B cross section in FIG. 4;

FIG. 7 is a schematic view of the fixing base in the second embodiment.

### DETAILED DESCRIPTION OF THE INVENTION

The present invention will be apparent from the following detailed description, which proceeds with reference to the accompanying drawings, wherein the same references relate to the same elements.

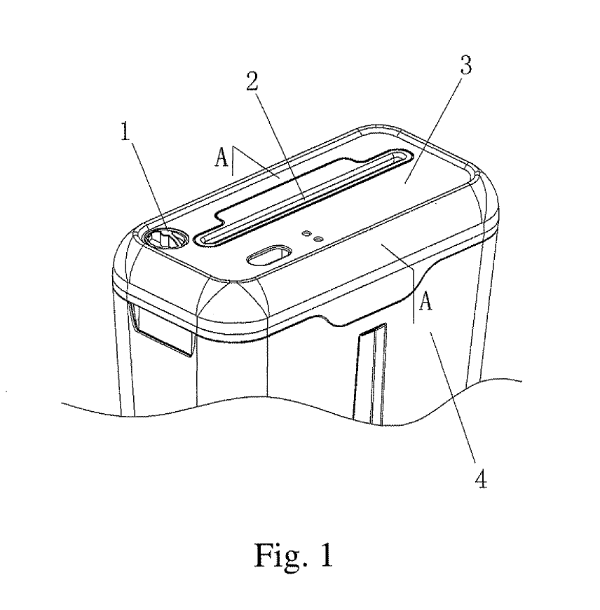

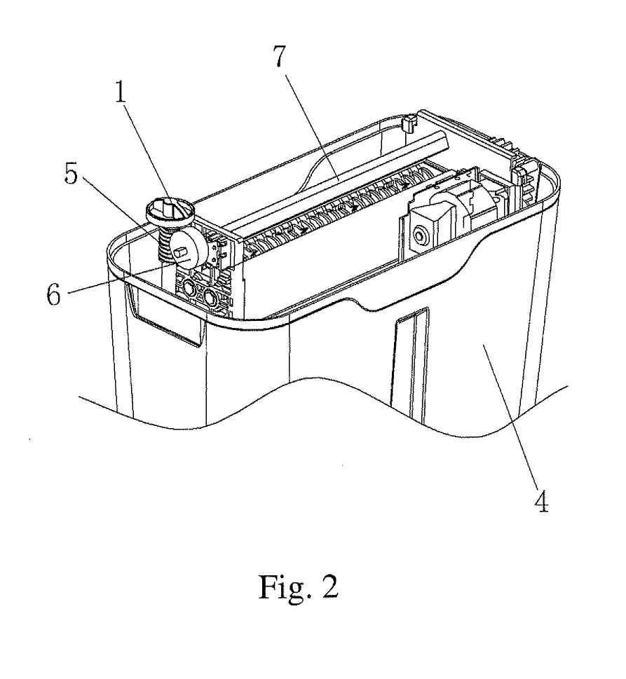

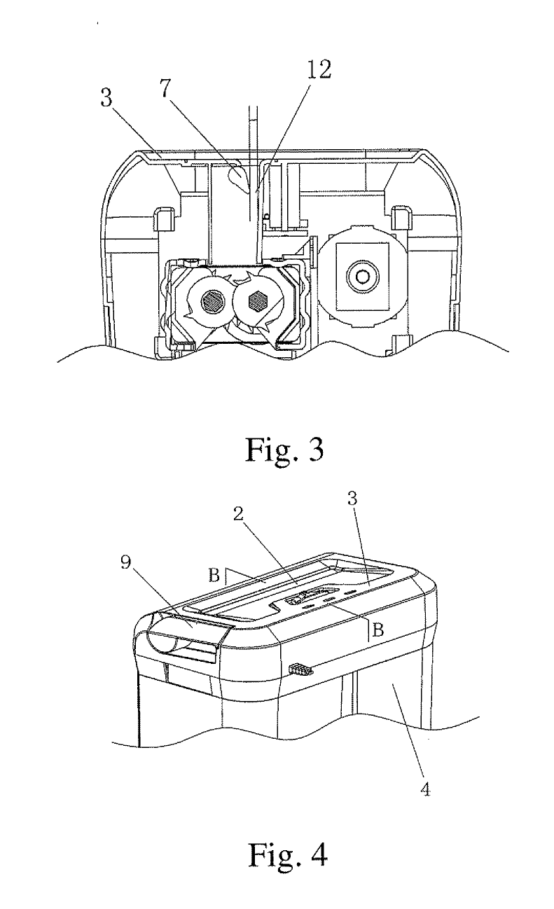

Please refer to FIGS. 1 to 3. The shredder with adjustable paper feeding opening according to a first embodiment of the invention includes a top cover 3 and a shredder body 4. The top cover 3 has a paper inlet 2. A rotatable adjusting bar 7 is provided beneath one side of the paper inlet 2. The adjusting bar 7 is parallel to the paper inlet 2. A paper feeding opening 12 forms between the adjusting bar 7 and the other side of the paper inlet 2. The adjusting bar 7 is controlled to rotate by an adjusting device.

The adjusting device includes a knob 1 on the top cover 3, a worm 5 connected and fixed to the knob 1, and a worm gear 6 connected with the worm 5. The worm gear 6 is connected and fixed to one end of the adjusting bar 7.

To adjust the size of the paper feeding opening 12, one simply rotates the knob 1 on the top cover 3. The knob 1 then rotates the worm 5, which in turn rotates the worm gear 6 that further rotates the adjusting bar 7. The size of the paper feeding opening 12 is thus adjusted.

The maximum width of the paper feeding opening 12 is the same as that of the paper inlet 2. Therefore, the width of the paper inlet 2 can be designed to be slightly larger. The paper feeding amount is then moderated by the width of the paper feeding opening 12.

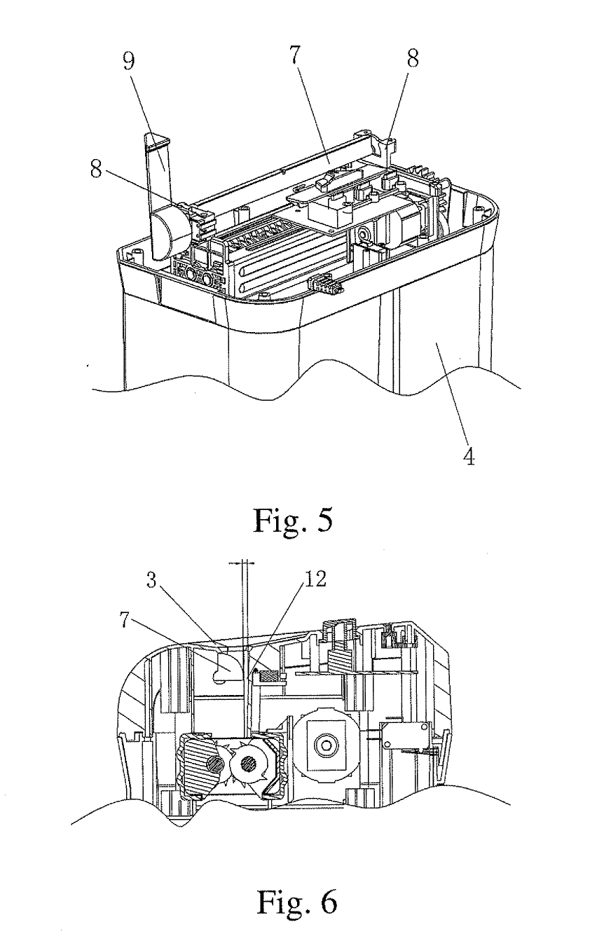

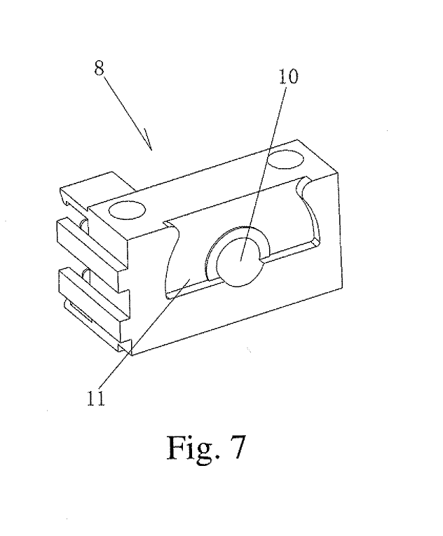

A second embodiment of the invention is shown in FIGS. 4 to 7. The second embodiment differs from the first embodiment in the adjusting device. The other parts are the same and are not repeated again.

The adjusting device in the second embodiment includes a handle 9 on the top cover 3 and two fixing bases 8 for supporting the adjusting bar 7. One end of the adjusting bar 7 goes through the corresponding fixing base 8 and connects to the handle 9.

Each of the fixing bases 8 has a fixing hole 10, around which is a concave part 11 for the adjusting bar 7 to rotate. The fixing holes 10 hold the ends of the adjusting bar 7. The concave parts 11 provide space needed for the rotation of the adjusting bar 7.

To adjust the size of the paper feeding opening 12, one simply rotates the handle 9 on the top cover 3. The handle 9 directly rotates the adjusting bar 7, thereby adjusting the size of the paper feeding opening 12.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shredder with adjustable paper feeding opening comprising a top cover having a paper inlet and a shredder body, characterized in that a rotatable adjusting bar is provided beneath one side of the paper inlet, the adjusting bar is parallel to the paper inlet, a paper feeding opening forms between the adjusting bar and the other side of the paper inlet, and the adjusting bar is controlled by an adjusting device.

2. The shredder with adjustable paper feeding opening as in claim 1, wherein the adjusting device includes a knob on the top cover, a worm connected and fixed to the knob, and a worm gear connected to the worm, and the worm gear is connected and fixed to one end of the adjusting bar.

3. The shredder with adjustable paper feeding opening as in claim 1, wherein the adjusting device includes a handle on the top cover and two fixing bases for supporting the adjusting bar, one end of the adjusting bar goes through the corresponding fixing base and connects to the handle.

4. The shredder with adjustable paper feeding opening as in claim 1, wherein each of the fixing bases has a fixing hole, and a concave part for the adjusting bar to rotate is formed around the fixing hole.
